(19) United States
(12) Patent Application Publication
(10) Pub. No.: US 2021/0357543 A1
(43) Pub. Date: Nov. 18, 2021

(54) METHOD AND SYSTEM FOR GENERATING ARTIFICIAL INTELLIGENCE-AIDED DESIGN SOLUTIONS AND TRAINING METHOD AND SYSTEM OF THE SAME

(71) Applicant: SMARTSCAPES STUDIO, S.L., Málaga (ES)

(72) Inventors: Juan BORDALLO RUIZ, Málaga (ES); Alejandro PLAZA YÂÑES, Málaga (ES)

(21) Appl. No.: 16/488,372

(22) PCT Filed: Jul. 17, 2019
(86) PCT No.: PCT/ES2019/070500

§ 371 Date: Aug. 23, 2019

(51) Int. Cl. G06F 30/13; G06F 30/20; G06N 20/00; G06K 9/62

(52) U.S. Cl. CPC G06F 30/13; G06K 9/6256; G06N 20/00; G06F 30/20

(57) ABSTRACT

The invention relates to a method for generating design solutions using an external database (1) and comprising the steps of: extracting (9) a set of design solutions from the database (1); defining (10) the values of a set of previously established standards which the desired design solution should meet; filtering (11) the extracted design solutions based on the set of standards introduced; establishing (12) a set of input parameters to be introduced; establishing (14) a validity interval for each one of the input parameters; introducing (16) the value of an input parameter or maintaining a default value previously stored; re-establishing the validity intervals (17) of the rest of the input parameters; repeating the process with each one of the input parameters; and generating (19) one or more valid design solutions.

### OBJECT OF THE INVENTION

The present invention is framed within the field of computer-aided design and more specifically, within the field of artificial intelligence-aided architectural design.

An object of the present invention relates to a method for generating design solutions and more specifically, to a method based on the computer algorithm-aided generation of architectural design solutions.

Another object of the present invention relates to a system for generating design solutions that executes the method for generating design solutions of the invention.

Another object of the present invention relates to a training method of the design solution generating algorithm of the method of the invention and the training system of said algorithm associated with the training method.

### BACKGROUND OF THE INVENTION

The generation of architectural solutions involves producing a solution that satisfies multiple design criteria within different scopes such as for example urban criteria, market or product criteria, constructive or technical criteria, economic criteria, architectural or aesthetic criteria. These criteria, which can be objective or subjective in nature, are what define the final result.

With the aim of adapting the design solutions to the imposed criteria, architects and designers currently work manually with conventional tools by means of a process based on trial and error and relying on their intuition and experience. Even when computer-aided design methods are used, the suitable application of the design criteria is usually carried out manually, the computer only facilitating the drawing process (CAD programs) and/or the digital construction process of a building (BIM environment).

In this way, the architectural project is at present planned as a progressive process carried out manually in which the designer, taking into account the design criteria of the project, draws a first design solution, based only on their own intuition and accumulated experience, in order for its result to then be evaluated manually with respect to the different criteria required for the project. The designer then remodifies the first solution generated, therefore producing different versions and adaptations to optimise the result. This process is repeated as many times as is necessary to achieve a satisfactory result. Therefore, the generation of a design solution meeting the criteria imposed is based on the skill and experience of the designer and on the success that they may have in each specific case.

This means that the current design generating process is slow, since the design has to be redrawn manually or by means of a CAD program continuously each time said design is optimised which means an increase in the cost of the project since it requires significant specialised manual intervention. In addition, the time, cost and success of generating a suitable solution mainly depend on the experience of the designer and their intuition and subjective criteria, the results in each project being different.

On the other hand, taking into account that the architectural process is a fundamental part of the construction of a new building, the mentioned drawbacks are projected towards the rest of the value chain of the construction to the final users of the building, who may encounter long waiting times and delays to the projects, increases in prices and quality limited by the manual nature of the process.

### DESCRIPTION OF THE INVENTION

The invention relates to two complementary methods, a first method for generating a design solution based on a set of input parameters and a second method for training a design solution generating algorithm.

The method for generating a design solution of the invention allows for a novel way of carrying out an architectural design aided by artificial intelligence and implemented by means of a computer.

The invention is based on defining architectural design algorithms which can be trained by means of machine learning methods and applied to the design of buildings.

The invention also relates to a system for generating design solutions comprising a database, which stores a set of design solutions, an assistance module for receiving a set of design solutions from the database, a set of input parameters and standards of the user and generating a set of output parameters fully defining valid design solutions, a design base module for receiving the design parameters fully defining the valid design solutions of the assistance module and generating a graphic representation and the measurement parameters of said design solutions, and a viewing module for allowing interaction with the user, such that it receives data from the user and shows to the user data of the assistance module and design base module.

The invention also relates to a system for training a design solution generating algorithm comprising a design parameter generator module for generating a set of design parameter combinations fully defining different design solutions, a design base module which receives the design parameter combinations from the design parameter generator module and generates a graphic representation from which a set of measurement parameters is extracted and a database which receives the parameters fully defining the different design solutions, the graphic representations of the same and the measurement parameters of the design base module and stores them.

As has been explained, both methods use a subprocess for representing a design solution based on defining a set of design parameters fully defining the design solution, also called the parametric definition of an architectural typology, such as for example double orientation multi-family housing, this subprocess for representing a design solution is carried out by means of the design base module.

Firstly, in this subprocess, the design parameters are introduced into the design base module which fully define a design solution, which may be viable or inviable, both exterior and interior parameters such as the width and length of the rooms, number of rooms, position of the rooms, and type of core, amongst others, then by means of a previously provided design algorithm already existing or created for the project, a graphic representation of the defined design solution and set of measurement parameters is produced.

The design base module, therefore, has the function of representing a design solution as a function of the design parameters fully defining the design, generating viable and inviable design solutions and extracting measurement parameters from the represented design. To do so, it has a geometry submodule which generates the graphic representation of the design and a metric submodule which generates the set of measurement parameters.

The method for generating solutions of the invention allows viable and optimised design solutions to be generated adaptively based on a set of known parameters and standards by means of an assistance module for generating valid solutions.

Firstly, a design solution database is provided which contains a set of ordered design solutions and a set of design solutions is extracted from said database. Preferably, this database is generated by means of the method for training a design solution generating algorithm by an administrator of the system.

Then, a set of design standards or criteria is defined which the desired design solution must meet based on a selection carried out by the administrator of the system and for which values are introduced by the user, such that the database is filtered according to the values given to the set of standards, whether they are standards from the client, product or market, such as minimum and maximum surface areas per room, minimum and maximum dimensions per room and surrounding situations of each room, thus obtaining a filtered set of design solutions that meets the set of standards introduced.

Then, from all the parameters defining the typology, a set of input parameters, also called design options, is established based on a selection carried out by the administrator of the system who establishes said design options, the value of which is defined by the user, aided by the system during the design process. This step can be carried out once or during the generation of each design solution.

With the aim of facilitating the input of data and avoiding the introduction of input parameters leading to inviable design solutions, a validity interval of each one of the values of the set of input parameters is obtained such that the user can select the specific value of each parameter within the provided validity interval. For each input parameter, the set of all the values that said parameter can take is established, for example the interval in which all the values are framed which said parameter takes in all the solutions contained in the database which have been previously supplied to the application, thus ensuring the viability of the solution.

In addition, each time the user introduces an input parameter, the validity interval of the input parameters remaining to be introduced is recalculated. The determination of the validity intervals can be carried out by any method of classification, indexation or database management as well as machine learning which offers dependency patterns of each variable.

Preferably, the calculation of the validity intervals is carried out by means of prior indexation of the data from the database in a data tree. To this end, the values of each one of the continuous design parameters in the database are discretised, for example, if the width of a home is 15.65 m and this field is discretised every 1 m, its discrete value will be 16 m, obtaining a discrete value for all the design parameters, both those which have been discretised and those which already had a discrete value. Then, each design solution is classified by an index which corresponds to the discretised values of the design parameters which will be used to carry out a query of the data in a subsequent step.

The result is a data tree in which each index groups combinations of design parameter values which give rise to viable design solutions which form a branch of the data tree which contains all the design solutions adhering to the values of the index. Thus, in the method for generating design solutions, the data tree allows the validity intervals of each one of the input parameters to be known.

This process of generating a data tree is carried out for each architectural typology existing in the project.

In the case of a project with various typologies (e.g. a residential building with two- or three-bedroom flats), the index corresponds to the common parameters of the homes. With the aim of combining the different architectural typologies in the same project, the set of indices of each typology are intersected, obtaining, as a result of the intersection, the indices coexisting in all the typologies at the same time, that is to say, the compatibility map of the typologies.

In the method for generating design solutions, the compatibility map allows the validity intervals of each one of the input parameters to be known such that when a value of an input parameter is introduced, filtering is carried out, leaving the design solutions whose indices comprise the value of the parameter introduced, producing the validity intervals of each one of the input parameters remaining to be introduced, i.e., the values of said input parameters which produce solutions meet the standards.

Thus, once the value of a first input parameter within a first interval of possibilities is introduced by the user, the database is filtered based on the indices applied and the value introduced, and a second more reduced interval of possibilities is obtained for the rest of the input parameters of the set of input parameters, these steps being repeated with all the input parameters until the last input parameter is reached.

Alternatively, the calculation of the new validity interval can be made discarding the values that belonged to the design solutions which are discarded based on the selection of the input parameter introduced and ensuring that the combination of the parameters introduced by the user corresponds to a valid design solution, producing a second filtering of the design solutions already filtered based on the set of standards, leaving only those that meet, in addition to the standards, the parameters introduced by the user without proceeding to index the database.

The values defined by the user for the set of input parameters, within the intervals of possibilities provided, involve defining the design by the user and its viability, that is to say, compliance with the standards defined initially by the user, is ensured by calculating the validity intervals.

In addition, after establishing the set of input parameters and before establishing the validity intervals, the set of input parameters can be hierarchised, that is to say, a dependency hierarchy is established from the most relevant input parameters to those with less involvement with the aim of determining the order of introducing the parameters defining the design. The definition of the required input parameters, the design options and the hierarchy of said parameters is carried out based on a selection carried out by the administrator of the system based on the compatibility map generated during the indexing of the database if this has been carried out. This hierarchisation allows the input parameters of the design process to be ordered from greater to lesser relevance, such that the introduction of less relevant parameters prior to others of greater relevance is avoided, thus preventing the possibility of the selection of the input parameters with greater relevance being conditioned by the selection of the input parameters of less importance, thus reducing the calculation time of the validity intervals. This step does not need to be carried out in each generation of a design solution, but can be carried out once by the administrator.

Lastly, once all the input parameters have been selected, a design solution meeting the selection of the input parameters introduced is generated by the application and obtained in real time.

The generation of the design solution consists of determining a set of output parameters generated from the standards, the set of input parameters and the design solution database filtered by the standards introduced, by means of machine learning algorithms. In particular, the set of output parameters can be obtained by means of a multivariable linear regression algorithm.

The method described can be carried out jointly for all the architectural typologies selected in the project, the parameters of each typology being analysed separately and the dependent parameters of the suitability among the different typologies, that is to say, based on a set of continuity rules by means of a calculation of the intersection between the validity intervals of each one of the input parameters of the different selected typologies described above, this means, for example, that it can be defined that the width of a building should be constant in all the homes of a straight façade linear block. Then, for each typology, after jointly defining the input parameters based on continuity rules, the parameters themselves of each typology unrelated to the rest are defined independently.

The set of standards and input and output parameters of the design can be introduced into the design base module to produce a graphic representation of the solution from which a set of measurement parameters of the generated viable design solution are obtained, which meet the standards and the set of input parameters introduced and output parameters generated.

Preferably, the set of output parameters obtained by the method described is under the control of the user, such that the user has the capacity to approve these parameters or modify them to seek another solution distinct from the one recommended.

Similarly, the selection of the input parameters can be carried out in an assisted manner such that a suggestion of the values is provided which optimise the design solution with respect to the metrics parameters of said design solution or specific ratio between parameters, for example in the case of a residential project, the habitable surface area, that is to say, the useful surface area of the home discounting hallways, bathrooms and pantries, the useful surface area ratio between constructed surface area, including the proportional part of the communal areas, the cost per square metre amongst others. Said measurement parameters and/or ratios are previously included in the database associated with each stored design solution. With the aim of providing a suggestion of an optimal value of a specific parameter or ratio, once the database is filtered with respect to the standards, during the selection of the input parameters, all the design solutions available are ordered in the indices resulting from said selection with respect to said parameter or ratio. This step is repeated for each typology existing in the project.

For example, in the case where the metric parameter selected for the optimisation is the total habitable surface area of a building, all the habitable surface area values of each home are multiplied by the number of homes of each typology, thus obtaining the total habitable surface area per typology, thus the sum of these habitable surface areas gives, as a result, the total habitable surface area for each option. Lastly, the design solutions are ordered with respect to the total habitable surface area which they produce and the design solution producing the greatest habitable surface area is selected, thus identifying the combination of input parameters producing the most optimal design solution with respect to the total habitable surface area among all the viable design solutions.

Similarly, the user can change the recommended values of the input parameters, introducing others; consequently, the process is repeated to calculate the remaining values producing the most optimal combination.

The introduction of the input parameters by the user can be carried out by means of the viewing module which allows a value to be established for each parameter in different ways, such as for example analytically, introducing the numeric data directly by means of a selector or interacting with the graphic representation of the design solution, whether it is 3D or 2D, such that the user can select the change to be carried out in said graphic representation.

The method for generating design solutions can allow the user to know in real time all the data of the project, the standards, the set of input parameters and the set of output parameters, such as for example existing architectural typologies, surface areas of each typology, surface areas of the different rooms and general urban data of the project and specific data for each typology, amongst others.

This method can also comprise a direct exporting step of the design to BIM environments which consists of applying a family or previously parametrised object to each one of the constructive components, such as a window or a door, amongst others, keeping the result in BIM format.

This feature allows the development of subsequent phases of the project to be carried out continually and seamlessly, since it digitalises the complete design process, not only the drawing or the construction of the building. This means that in subsequent phases the generated geometries can be recognised as architectural entities which allows the handling and processing of the same.

Similarly, the definition of the constructive entities in a BIM environment allows the implementation of an optimisation module comprising a search generating algorithm in conjunction with an environmental simulator which provides environmental metrics. The search algorithm of the optimisation module enables environmental criteria to be applied to the final solution, finding the optimal design solution based on a calculation of the energy consumption.

In order to carry out the calculation of the energy consumption, the system can comprise a simulation and calculation algorithm that receives a set of environmental data and data on the surroundings from the administrator of the system and stores them in a database. Then, once a viable design solution has been stored, the energy consumption is calculated for this design solution, carrying out a simulation of the environmental conditions, with the aim of generating environmental metrics. Then, a genetic algorithm is applied which modifies the position and composition of some constructive elements without altering the definition of the generated design solution, such that the energy consumption is minimised, that is to say, the modification is carried out on the position of constructive elements which do not alter the design solution and on the materials, thicknesses, layers, amongst others, of the materials composing said constructive elements. The modification of the constructive elements can comprise, for example, a change in the arrangement of terraces, the windows or materials of the exterior enclosures.

In addition, with the aim of optimising the modification of the constructive elements, a genetic algorithm is used which enables the different positions and compositions of the constructive elements to be iterated with the aim of finding the one that has the lowest energy consumption.

This same process described for the automated environmental optimisation of the solution is applicable to the optimisation based on other criteria, such as economic criteria, cost-benefit criteria or another type, as well as multi-objective optimisations where the system optimises the solution with respect to various parameters at the same time.

On the other hand, the method for generating design solutions can also automate the calculation of the budget of the construction of the design in real time. To this end, previously stored data on prices of each item is used and is applied to the measurement resulting from each entity generated, for example, the previously stored price of the structure square metre is applied to the structure surface area. This feature allows the economic repercussion which each decision has on the input parameters and the standards within the design process to be known.

The method for generating design solutions of the invention can also comprise a previous step of automatically determining the optimal arrangement of the buildings which form the project on an empty lot, in relation to measurable optimisation criteria, based on the definition of said empty lot and a set of data of the surroundings previously provided by the administrator of the system. The definition of the optimal architectural arrangement uses a set of values obtained for the measurable optimisation criteria for a specific arrangement, calculated by means of carrying out a simulation of said arrangement, such as the environmental criteria like energy consumption, economic criteria like cost or benefits, or functional criteria like accessibility, thus obtaining the optimal architectural arrangement for the lot and the data on its surroundings previously introduced. In particular, the definition of the optimal architectural arrangement can be obtained iterating the different architectural typologies of the buildings which form the arrangement until finding the optimal one based on one of the previously defined optimisation criteria, such as the consumption or minimum cost criteria.

The method for generating design solutions of the invention allows for an increase in the precision and efficiency of the traditional process, drastically reducing the design time and development of the architectural project to produce optimal design solutions in real time.

Thus, the method allows the designer to free themselves from the mechanical development tasks in order to concentrate on making decisions concerning the design and thus improving its added value.

In addition, it allows greater digitalisation of a sector based on the intensive use of high-cost specialised labour by means of introducing novel artificial intelligence technologies which allows a more efficient and informed design process reducing the dependency on intuition.

Consequently, the described method improves the decisions, since it allows a multitude of variants concerning a project to be carried out in a very short time with the guarantee of providing optimised solutions without human error, improving productivity whilst reducing the design time and improving profitability whilst optimising the projects and reducing expenses to increase the benefit.

Similarly, these advantages extend to the other agents involved in the construction supply chain such as architects, project managers, urban planners and public institutions, as well as the final user who can receive an improved product better adapted to their requirements and their needs, and more quickly and economically as the production costs are reduced.

On the other hand, the method for training a design solution generating algorithm is based on the exploration of viable design solutions which can be generated within a scope of design parameters, provided by the administrator of the system by means of a design parameter generating module.

This method therefore allows a set of design parameters to be generated iteratively fully defining the design and using the design base module, generating the graphic representation and the measurement parameters of a design solution for each set of design parameters generated.

The proposed training method therefore comprises the steps of establishing a first set of design parameters previously defined by the administrator of the system and obtaining multiple combinations of said design parameters by means of applying a design parameter generating routine consistent with an algorithm which scans all the combinations of parameters homogenously or selectively, taking into account the combinations already generated.

Then, a graphic representation is generated of each solution defined by each combination of design parameters, from which a set of measurement parameters is extracted by means of the design base module, thus representing a design solution for each one of the combinations of design parameters obtained. Lastly, the design solutions obtained for all the combinations of design parameters are stored in the database.

Preferably, the graphic representation of the design solution can be stored in the database instead of storing only the parameters defining it. Thus, time is saved in the method for generating design solutions as it is not necessary to generate the graphic representation of the design solution, but rather it is loaded directly from the database.

With the aim of optimising the storage of the design solutions in the database, said design solutions previously generated based on their features, such as architectural typology, the standards they meet, the parameters of the interior and exterior, amongst others can be ordered.

In addition, the storage space in the database can be optimised if a design solution filter is included which discards the solutions generated which do not meet minimum acceptance criteria, which cannot correspond to surface areas, dimensions or proximity rules. In this way, a minimum quality is ensured in the solutions which are ultimately stored in the design solution database.

The method for generating design parameters allows combinations of design parameters to be generated which include, for example continuous parameters such as the total width of a home, its length, dimensions of each room or discrete design parameters such as the staircase core type, the position thereof in the building, the position of the kitchen, front or rear, of the master bedroom, amongst others. In addition, the module for generating design parameters can be of a standard type which allows all the possible or genetic type parameter combinations to be searched, which allows a genetic algorithm to be sought in an optimised manner, with the aim of scanning the entire spectrum of possible combinations among the parameters, whether homogenously in the case of a standard type or more selectively in the case of a genetic type. In the case of the design parameter generating module being of a genetic type, the search is carried out as a function of the combinations of parameters already generated, which allows the combinations of parameters meeting the minimum criteria to be searched for more efficiently, as the search algorithm is implemented with a genetic type algorithm which discards the combinations not meeting said minimum criteria and is concentrated on those that do meet them.

The system is therefore progressive and increases its functionality as the generated database grows. This aspect allows its applicability to be increased with respect to the different functionalities and variants which a typology can have and increase its reach in different markets.

### DESCRIPTION OF THE DRAWINGS

In order to complement the description being made and with the aim of helping to better understand the features of the invention in accordance with a practical preferred exemplary embodiment of the same, said description is accompanied, as an integral part thereof, by a set of drawings where, in an illustrative and non-limiting manner, the following has been represented:

FIG. 1 shows a schematic drawing of a preferred embodiment of the system for generating design solutions of the invention.

FIG. 2 shows a schematic drawing of a preferred embodiment of the design base module.

FIG. 3 shows a diagram of an embodiment of the method for generating design solutions of the invention.

FIG. 4 shows a schematic drawing of a preferred embodiment of the system for training a design solution generating algorithm of the invention.

FIG. 5 shows a diagram of an embodiment of the method for generating design solutions of the invention.

### PREFERRED EMBODIMENT OF THE INVENTION

The invention relates to a method for generating design solutions and the associated system for generating design solutions.

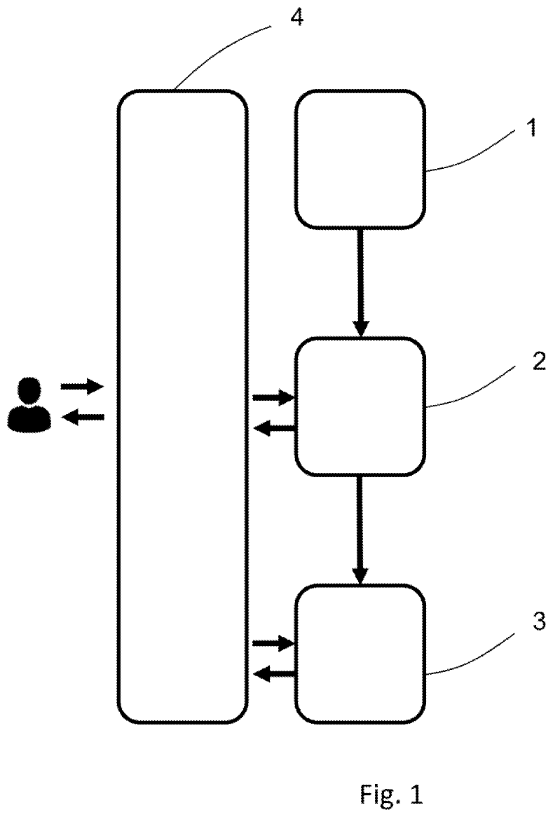

FIG. 1 shows a preferred embodiment of the system for generating design solutions which executes the method of the invention. The system comprises a database (1), an assistance module (2) for generating valid solutions, a design base module (3) and a viewing module (4).

The database (1) comprises a set of design solutions stored such that it supplies the assistance module (2). Said assistance module (2) interacts with the user by means of the viewing module (4) such that it receives a set of input parameters which the user introduces and produces a set of output parameters, such that the set of input and output parameters fully define the design.

The assistance module (2) is connected to the design base module (3) and transmits to it the input parameters introduced by the user and the output parameters, generated by the assistance module (2) itself, forming a set of design parameters fully defining the design solution. The design base module (3) receives the design parameters and generates a graphic representation of the design solution from which a set of measurement parameters are extracted. The design base module (3) can also interact with the user, showing by means of the viewing module (4) the graphic representation and the measurement parameters generated and allowing their modification by the user.

During the entire operation of the assistance module (2) and of the design base module (3), the user has complete control by means of the viewing module (4), therefore allowing the modification of the parameters defining the design at any time.

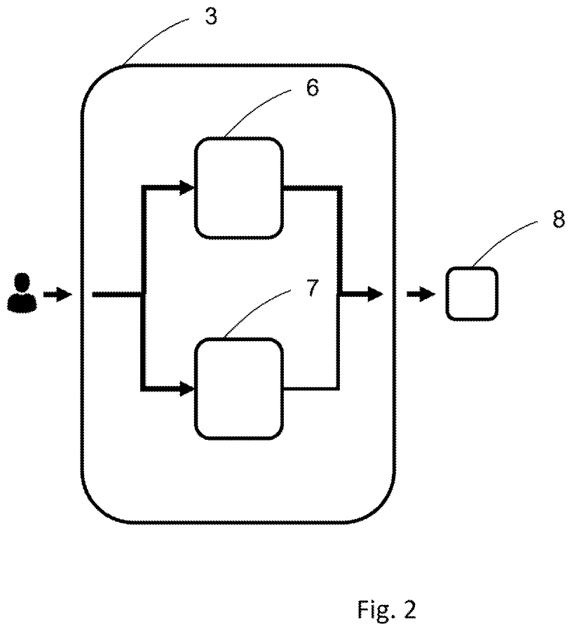

FIG. 2 shows a schematic drawing of a preferred method of operating the design base module (3). The design base module (3) receives a set of design parameters which include specifications of the design, data on the definition of the building and data on the definition of the home, which pass to a calculation module which comprises a geometry submodule (6) which generates a graphic representation of a design solution and a metric submodule (7) which generates a set of measurement parameters. This module (3) is therefore responsible for representing the design solution (8) whilst supplying it with all the design parameters defining the design solution.

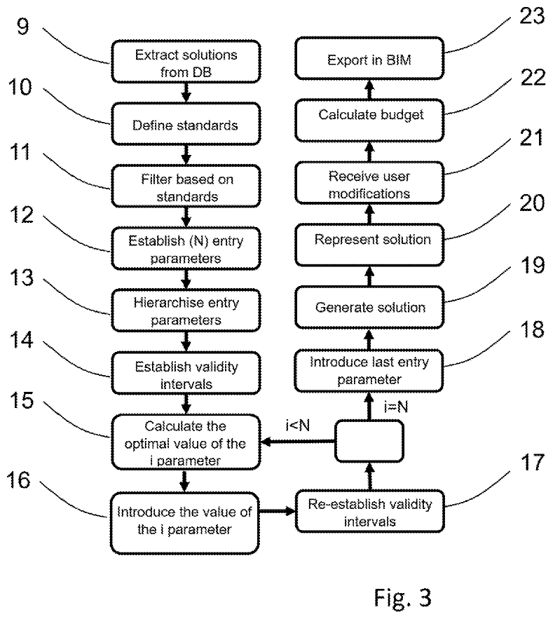

FIG. 3 shows a preferred embodiment of the method for generating design solutions of the invention which is carried out by means of an application forming part of the assistance module (2).

The application that executes the method therefore firstly extracts (9) a set of available valid design solutions stored in the design solution database (1).

Then, the application defines the architectural typology intended to be used based on a series of standards of the client, product or market, previously established by the administrator of the system and whose value is defined by the user. The defining (10) of the standards by the user allows the application to carry out a first filtering (11) of the solutions provided by the database (1), therefore leaving only the solutions meeting said standards. Preferably, the user can select various sets of standards such that the method is capable of simultaneously generating valid design solutions for various architectural typologies which, in this case, belong to the same project and therefore share common features.

Then, the application establishes (12) the input parameters that the user has to introduce based on a selection by an administrator of the system as is shown in FIG. 3, N input parameters are established. In each project, the number and type of input parameters that the administrator of the system establishes can be different. For example, the input parameters can comprise the parameters of the exterior and the interior of the home, both geometric and metric, the definition of the building, that is to say the features shared by all the homes with the aim of being linked to one building typology and the architectural typology of the home.

With the aim of optimising the functionality of the application and therefore of the method of the invention, the input parameters are hierarchised (13), that is to say, they are ordered based on their important in the final design, the administrator of the system being the one who defines the hierarchical order of the input parameters, that is to say, the design options such that the first input parameters that the application requires of the user are the most important ones in defining the design, for example, in the case of a multi-family home, the total width of the home has more effect on the final design of the home than the type of stairs of the building.

Based on this hierarchisation, the application establishes (14) the validity intervals of the input parameters, such that for each one the set of all the values is established which said parameter takes in all the solutions contained in the database (1) which have been previously supplied to the application, once they have been filtered by the standards imposed by the user.

In addition, for the N input parameters, each time a validity interval is established, the application calculates (15) and provides the value of the parameter within the interval which allows an optimal design solution to be generated, being a design solution maximising or minimising one or more previously defined optimisation criteria, whether they are parameters or ratios. Thus, the step of introducing (16) the value of an input parameter consists of maintaining or modifying the suggested value. Then, the combinations of viable parameters meeting the introduced parameter are filtered and the validity interval of all the other dependent input parameters is recalculated (17) according to the hierarchy, said validity interval being reduced as the values, which belonged to discarded solutions, are discarded, ensuring that the combination of the parameters that the user introduces corresponds to a valid design solution.

Thus, when a parameter i is introduced, where i is a natural number from 1 to N, whether it is the value provided by the application that allows an optimal design solution to be generated or the value modified manually by the user, the viable combinations are filtered by the parameter i introduced and the validity intervals of the rest of the parameters are re-established (17). The process is repeated until i is equal to N, that is to say, until the last parameter is reached. Then, the last input parameter (18) is introduced within the validity interval of the last parameter or the recommend one is maintained. Lastly, a machine learning algorithm is applied to generate (19) design solutions which, based on the standards, the input parameters and the database filtered by the standards, calculates a set of output parameters completing the definition of the valid design solution generated.

Said generating of design solutions is fully produced after the introduction of any parameter defining the design, since the rest of the parameters have a default value, thus the user can know the result of each modification carried out during the process and proceed to introduce the rest of the parameters in an informed manner, owing to the data which is presented, and guided, owing to the suggestions provided by the system.

Then, a graphic representation (20) of the generated design solutions is generated by means of the design base module (3). Preferably, the design solutions already represented can be stored in the design solution database (1). In this way, it is not necessary regenerate the representation of the valid design solutions, since their representation would already be generated.

The result is then shown to the user by means of the viewing module (4) who should decide if the design meets their expectations. In this respect, the method of the invention allows the user to modify (21) the generated solution, changing the parameters defining it, even if this involves the generation of an inviable solution.

The application can then calculate an estimation of the construction budget (22) of the generated design. To this end, data previously stored in a price database (1) is extracted which can coincide with the design solution database (1) which contains the price of materials per unit of measurement. The application then applies these prices to the measurements of the design solution generated, estimating the price of said construction.

Lastly, the solution (23) is exported in a BIM environment with the aim of supplying the subsequent digital construction process.

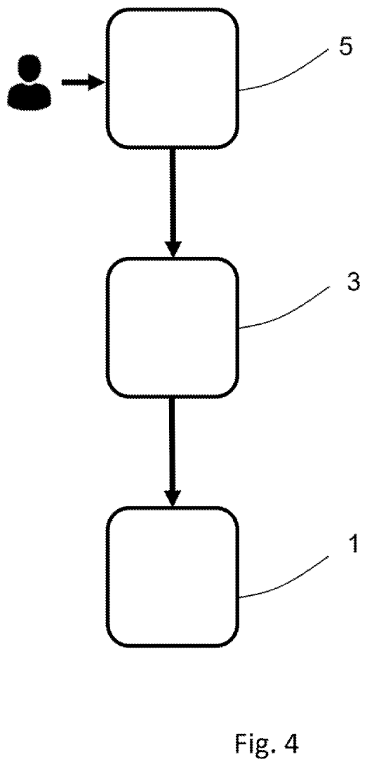

The invention also relates to a method for training a design solution generating algorithm and a training system associated with said method. FIG. 4 shows a preferred embodiment of the training system which comprises a design parameter generating module (5), a base design model (3), similar to the one used in the system for generating design solutions and a database (1).

The design parameter generating module (5) of the system receives from the administrator of the system a scope of variation of the design parameters and generates multiple combinations of said design parameters, such that the spectrum of possible combinations is scanned, in this case homogeneously when it concerns a standard module.

The design parameter generating module (5) transmits the combinations of viable design parameters generated to the design base module (3).

The design base module (3), like the system for generating design solutions, receives the design parameters and generates a graphic representation of the design solution from which a set of measurement parameters is extracted.

The set of design parameters which allows for the graphic representation of the design solution is then stored in the database (1) which can be used as the design solution database (1) of the system for generating design solutions. Either the complete set of data, which allows for the graphic representation of the design together with the measurement parameters, or the graphic representation itself of the design with the parameters defining it and their measurement parameters can be stored in said database (1).

With the aim of optimising the storage of the design solutions in the database (1), said previously generated design solutions can be ordered based on their features such as architectural typology, the standards they meet, the parameters of the interior and exterior, amongst others.

In addition, the storage space in the database (1) can be optimised if a design solution filter is included which filters the solutions generated that do not meet minimum acceptance criteria. In this way, a minimum quality is ensured in the solutions which are ultimately stored in the design solution database (1). To this end, once the measurement parameters of the design solutions have been obtained from each combination of design parameters, the solutions considered invalid by the design solution filter are discarded.

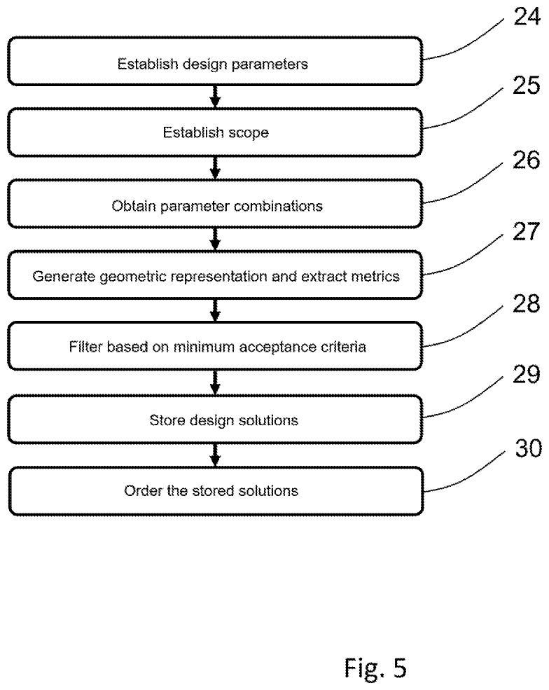

FIG. 5 shows a graphic representation of the succession of steps produced in a preferred embodiment of the training method of the invention, in this case by means of an application.

Firstly, the application, by means of the design parameter generating module (5), establishes (24) the design parameters of the typology, then, it establishes (25), based on a selection by the administrator, a maximum scope of values that a first set of design parameters can take. The parameters composing the first set of design parameters can be previously defined (24) by an administrator of the system as shown in FIG. 5.

Combinations of design parameters of the first set of design parameters are then generated (26) by means of the design parameter generating module (5), scanning the entire spectrum of possible combinations within the specified scope. The application is responsible in these steps for determining that the first set of parameters contains all the design parameters necessary for defining the design solution.

Then, by means of the design base module (3), a graphic representation is generated (27) for each combination of design parameters generated from which a set of measurement parameters is extracted.

The design solutions generated based on minimum acceptance criteria previously provided by the user are then filtered (28).

A design solution for each combination of design parameters generated is then stored (29) by the parameter generating module (5) in the database (1) which will then be used as the design solution database (1) for the system for generating design solutions.

Lastly, the solutions generated and stored are ordered (30) based on their design parameters in the database (1) such that they are indexed.

Although the systems and methods described relate to the design of collective housing residential buildings, this method is applicable to any architectural typology, such as single-family homes, other residential typologies (hotels, residences, etc.), educational infrastructures (schools, institutes, universities, etc.), healthcare facilities (hospitals, clinics, etc.), cultural, religious facilities etc.

1. A method for generating design solutions using an external database and comprising the steps of:
extracting a set of design solutions from the database;
defining based on a selection by a user, the values of a set of standards previously established, based on a selection by an administrator of the system, which the desired design solution should meet;
filtering the design solutions extracted, based on the set of standards introduced;
establishing a set of input parameters to be introduced, based on a selection by the administrator of the system;
establishing a validity interval for each one of the input parameters of the established set of input parameters, coinciding with the interval of values that each parameter takes in the valid design solutions stored in the database;
introducing the value of an input parameter, or maintaining a previously stored default value, based on a selection by the user;
re-establishing the validity intervals of all the input parameters, except the input parameter whose value has already been introduced by the user;
repeating the two previous steps with each one of the input parameters except a last input parameter;
introducing the value of the last input parameter or maintaining a previously stored default value; and
generating one or more valid design solutions.

2. The method for generating design solutions of claim 1, wherein the step of generating one or more valid design solutions is carried out by means of machine learning algorithms.

3. The method for generating design solutions of claim 1, wherein the step of establishing a validity interval for each one of the input parameters is carried out by means of prior indexation of the data contained in the database and generating a data tree in which the validity interval corresponds to the values taken by the design solutions contained in one of the branches, that is to say, that they meet one or more specific indices determined by means of the input parameters introduced by the user.

4. The method for generating design solutions of claim 1, wherein the step of establishing a validity interval for each one of the input parameters is carried out by means of filtering the data contained in the database, wherein the validity interval corresponds to the values taken by the design solutions filtered based on the input parameters introduced by the user.

5. The method for generating design solutions of claim 1, which further comprises a step, prior to the step of introduction the value of an input parameter of hierarchising the input parameters, based on a selection by the administrator of the system, wherein the input parameters are ordered by means of a dependency hierarchy based on their influence on the design solution.

6. The method for generating design solutions of claim 1, wherein design solutions valid for various architectural typologies are generated simultaneously.

7. The method for generating design solutions of claim 6, wherein the architectural typologies are related to one another based on a set of continuity rules and which further comprises a step of simultaneously limiting the validity intervals of the input parameters of various architectural typologies based on the continuity rules.

8. The method for generating design solutions according to claim 1, which comprises an additional step of calculating the value of an input parameter which allows an optimal design solution to be obtained, being a solution which maximises or minimises one or more previously defined optimisation criteria, such that the step of introducing the value of an input parameter consists of maintaining or modifying the suggested value.

9. The method for generating design solutions of claim 1, which further comprises a step of generating a graphic representation of the design solution obtained and extracting a set of measurement parameters.

10. (canceled)

11. The method for generating design solutions of claim 1, which comprises an additional step of calculating the budget derived from the construction of the design solutions, obtained by means of applying data, previously stored in the database, of prices of each item on the resulting measurement of each entity generated.

12. (canceled)

13. The method for generating design solutions of claim 1, which further comprises the steps of:
applying a calculation algorithm which receives a set of environmental data and data of the surroundings, from the administrator of the system, and calculates the energy consumption for a design solution,
modifying the position and composition of some previously determined constructive elements without altering the definition of the generated design in order to minimise the energy consumption.

14. The method for generating design solutions of claim 1, which further comprises the steps of:
receiving data on the definition of an empty lot and a set of data on the surroundings provided by the administrator of the system;
obtaining the optimal architectural arrangement for the lot and the introduced data on its surroundings, the optimal architectural arrangement being that which maximises or minimises previously defined optimisation criteria.

15. The method for generating design solutions of claim 1, further comprising a step of training a design solution generating algorithm, wherein the set of solutions stored in the database generated following the steps of:
providing a design base module adapted for generating a graphic representation based on a set of design parameters and extracting a set of measurement parameters;
establishing a first set of design parameters;
establishing, based on a selection by an administrator of the system, the scope of the first set of design parameters;
obtaining multiple combinations of design parameters by means of applying a design parameter generating routine to the first set of design parameters established;
generating a graphic representation of each design solution defined by each combination of design parameters and extracting a set of measurement parameters by means of the design base module; and
storing in the database the design solutions defined by the set of design parameters and the set of measurement parameters for each one of the combinations of design parameters obtained.

16. The method for generating design solutions of claim 15, wherein the step of storing in the database further comprises the graphic representation of the design solution obtained for each one of the combinations of design parameters obtained.

17. The method for generating design solutions of claim 15, wherein it comprises an additional step of ordering the design solutions stored in the database based on the design parameters defining them.

18. The method for Cr generating design solutions of claim 15, wherein it comprises an additional step of filtering the design solutions obtained based on minimum acceptance criteria.

19. A system for generating design solutions configured for carrying out the method of claim 1, which comprises:
a database which stores a set of design solutions,
an assistance module intended to receive a set of design solutions of the database and a set of input parameters and standards of the user and generate a set of output parameters which complete the definition of the valid design solution which meets the set of input and output parameters and standards;
a design base module intended to receive the parameters fully defining the design solutions of the assistance module and generate a graphic representation of said design solutions and extract a set of measurement parameters from said design solutions;
a viewing module connected to the assistance module and the design base module and intended to interact with the user and configured to receive data from the user and show the user data from the assistance module and the design base module.

20. The system for generating design solutions of claim 19, further comprising:
a design parameter generating module intended to generate a set of combinations of design parameters fully defining different design solutions;
a design base module intended to receive the combinations of design parameters fully defining the different design solutions from the design parameter generating module and generate a graphic representation of said design solutions and extract a set of measurement parameters from said design solutions;
a database intended to receive the parameters fully defining the different design solutions and the measurement parameters of the design base module and store said parameters.

21.-24. (canceled)
